(19) United States
(12) Patent Application Publication
(10) Pub. No.: US 2004/0100890 A1
(43) Pub. Date: May 27, 2004

(54) Method and apparatus for discriminating a disc type

(75) Inventor: Jong-Jin Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/617,174

(22) Filed: Jul. 11, 2003

(30) Foreign Application Priority Data
Nov. 22, 2002 (KR) 2002-73042

(51) Int. Cl. G11B 7/00

(52) U.S. Cl. 369/53.23

(57) ABSTRACT

An apparatus and method therefor to discriminate a type of disc including a motor rotating a disc, a pickup detecting light reflected from the disc, and a system controller. The system controller performs a control process of enabling a focusing operation on the disc while stopping an operation of the motor in a disc type discrimination mode and discriminates the type of disc according to a result of detecting a time corresponding to a distance from a surface of the disc to a data recording layer of the disc using a light reflected during the focusing operation on the disc.

### BACKGROUND OF THE INVENTION

This application claims the priority of Korean Patent Application No. 2002-73042, filed on Nov. 22, 2002, in the Korean Intellectual Property Office, the disclosure of which is incorporated herein in its entirety by reference.

1. Field of the Invention

The present invention relates to a method and apparatus for discriminating a type of a disc in a disc drive, and more particularly, to a method and apparatus for discriminating a type of a disc, which can reduce a disc type discrimination error due to disc unbalance.

2. Description of the Related Art

CD (compact discs) disc types and DVD (digital versatile disc ) disc types are widely used. A distance from a disc surface to a data recording layer of the CD disc type is about 1.2 mm, while in the case of the DVD disc type the distance is about 0.6 mm.

Accordingly, a conventional disc drive discriminates between the CD disc type and the DVD disc type using a difference in the distance from a detected point of light reflected from the disc surface area to a detected point of light reflected from the data recording layer while the disc is rotating.

However, in a case where the disc inserted in the disc drive is an unbalanced disc, an error is likely to occur when detecting the above-mentioned distance while the disc is rotating. The unbalanced disc may be a disc having a surface inclination obtained in a manufacturing process or during distribution. When the unbalanced disc is rotating, the data recording layer of the disc can vary between a plane “A” and a plane “C” as shown in FIG. 1. Accordingly, while a reflection from the disc surface occurs at a point “a”, a reflection from the data recording layer can occur at a point “c”. In this case, an actuator of a pickup moves up and down an objective lens to adjust focusing errors. If a moving speed of the objective lens is the same as a changing speed of a reflection point on the data recording layer due to the disc unbalance, the distance from the reflection point on the disc surface to the reflection point on the data recording layer can increase. In this case, even when the DVD disc type is inserted in the disc drive, the disc can be erroneously discriminated as the CD disc type.

On the other hand, if the changing speed of the reflection point on the data recording layer due to the disc unbalance is faster than the moving speed of the objective lens, the distance from the reflection point on the disc surface to the reflection point on the data recording layer can decrease. In this case, even when the CD disc type is inserted in the disc drive, the disc can be erroneously discriminated as the DVD disc type.

### SUMMARY OF THE INVENTION

Additional aspects and/or advantages of the invention will be set forth in part in the description which follows and, in part, will be obvious from the description, or may be learned by practice of the invention.

According to aspect of the present invention, there is provided a method and apparatus for discriminating a type of a disc in consideration of disc unbalance.

The present invention also provides a method and apparatus for discriminating a type of a disc without rotating the disc.

Further, according to an aspect of the present invention, the invention provides a method and apparatus for discriminating between a CD and a DVD in consideration of disc unbalance.

According to an aspect of the present invention, there is provided a method of discriminating a type of a disc, which includes stopping an operation of a motor rotating a disc; detecting a time corresponding to a distance from a surface of the disc to a data recording layer of the disc using light reflected during a focusing operation; and discriminating the type of disc by comparing the detected time and a reference value.

The detection of the time corresponding to the distance comprising detecting the time using a focusing error signal detected during the focusing operation.

The discrimination of the type of disc comprises determining the disc as a CD disc type when the detected time is greater than the reference value and as a DVD disc type when the detected time is less than the reference value.

According to another aspect of the present invention, there is provided an apparatus for discriminating a type of a disc, which includes a motor rotating a disc; a pickup detecting light reflected from the disc; and a system controller performing a control process of enabling a focusing operation on the disc while stopping an operation of the motor in a disc type discrimination mode and discriminating the type of disc according to a result of detecting a time corresponding to a distance from a surface of the disc to a data recording layer of the disc using a light reflected during the focusing operation on the disc.

According to an aspect of the present invention, the apparatus further includes an amplifying unit producing a focusing error signal based on a light signal output from the pickup, wherein the system controller utilizes the focusing error signal to detect the time.

The system controller determines the disc as a CD disc type when the detected time is greater than a reference value and as a DVD disc type when the detected time is less than the reference value.

According to an aspect of the present invention, there is provided an apparatus to discriminate a type of a disc, including: a motor; a pickup detecting an amount of light reflected on the disc; a driving circuit controlling the pickup to perform a focusing operation on the disc; a radio frequency (RF) amplifier converting the amount of light detected into electrical signals and outputting a focus error (FE) signal and the electrical signals; and a system controller discriminating the type of the disc while the focusing operation is performed and an operation of the motor is stopped, according to a result of detecting a time corresponding to a distance from a surface of the disc to a data recording layer of the disc using the electrical signals and the FE signal.

According to an aspect of the present invention, there is provided a method of discriminating a type of disc in a disc drive, which comprises a disc, a servo controller, a spindle motor, a pickup, and a system controller, the method including: outputting a control signal to a servo controller to turn on the pickup while turning off the spindle motor; performing the focusing operation on the disc; detecting a time corresponding to a distance from a surface of the disc to a data recording layer of the disc using an amount of light reflected on the disc and an FE signal; and comparing the time with a reference value; wherein if the detected time is greater than the reference value the disc is determined to be a CD disc type, or if the detected time is less than the reference value the disc is determined to be a DVD disc type.

According to an aspect of the present invention, there is provided a method of discriminating a type of a disc in a disc drive including a pickup and a motor, the method including: detecting an amount of light reflected by the disc; controlling the pickup to perform a focusing operation on the disc; converting the amount of light detected into electrical signals and outputting a focus error (FE) signal; and discriminating the type of the disc while the focusing operation is performed and an operation of the motor is stopped, according to a result of detecting a time corresponding to a distance from a surface of the disc to a data recording layer of the disc using the electrical signals and the FE signal.

### BRIEF DESCRIPTION OF THE DRAWINGS

These and/or other aspects and/or advantages of the invention will become apparent and more readily appreciated from the following description of the aspects of the present invention, taken in conjunction with the accompanying drawings of which:

FIG. 1 is a schematic diagram provided to illustrate a surface reflection and data recoding surface reflection of an unbalanced disc;

FIG. 2 is a block diagram of a disc drive including an apparatus to discriminate a disc type, according to an aspect of the present invention;

FIGS. 3A and 3B show waveforms of a reflection signal and a focusing error signal, which are detected during a focusing operation of the disc drive; and

FIG. 4 is a flowchart of a method of discriminating the type of disc, according to an aspect of the present invention.

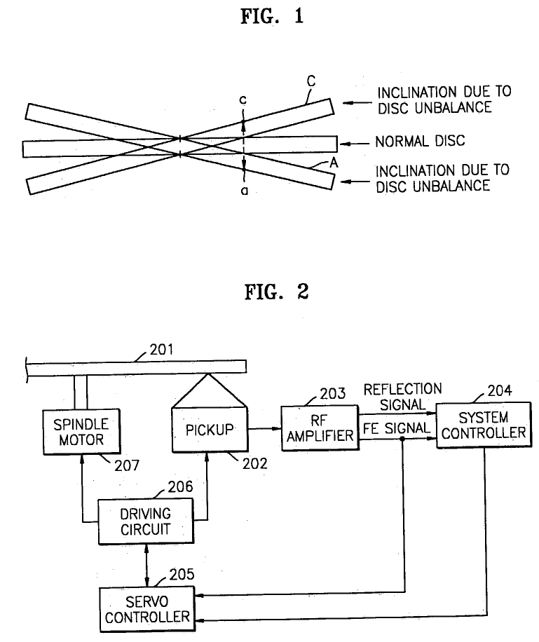

### DETAILED DESCRIPTION OF THE INVENTION

Reference will now be made in detail to the aspects of the present invention, examples of which are illustrated in the accompanying drawings, wherein like reference numerals refer to like elements throughout. The aspects are described below in order to explain the present invention by referring to the figures.

FIG. 2 is a block diagram of a disc drive including an apparatus to discriminate a disc type, according to an aspect of the present invention. Referring to FIG. 2, the disc drive includes a disc 201, a pickup 202, a radio frequency (RF) amplifier 203, a system controller 204, a servo controller 205, a driving circuit 206, and a spindle motor 207.

The disc 201 is a reproducible or recordable/reproducible disc and may be either a CD or a DVD.

Like a pickup included in a conventional disc drive, the pickup 202 includes an objective lens (not shown), an actuator (not shown) for driving the objective lens, a laser diode (not shown), and an optical detector (not shown). When the disc 201 is inserted into the disc drive, the driving circuit 206 controls the actuator of the pickup 202 to perform a focusing operation on the disc 201 while moving the objective lens up and down. Further, the pickup 202 detects a light signal indicative of an amount of light reflected on the disc 201. The amount of reflected light is detected using the optical detector based on a converged light via the objective lens. The light signal detected using the optical detector is then provided to the RF amplifier 203.

The RF amplifier 203 converts the light signal detected via the optical detector into electrical signals and provides the electrical signals to the system controller 204. Further, the RF amplifier 203 provides the system controller 204 and the servo controller 205 with a focus error (FE) signal of an RF signal transmitted from the pickup 202.

When the disc drive is in a disc discrimination mode, the system controller 204 stops an operation of the spindle motor 207 via the servo controller 205 and controls the pickup 202 to perform the focusing operation on the disc 201. Then, the system controller 204 detects a time corresponding to a distance from a surface to a data recording layer of the disc 201 based on the reflected light signal and the focus error (FE) signal transmitted from the RF amplifier 203 according to the focusing operation on the disc 201.

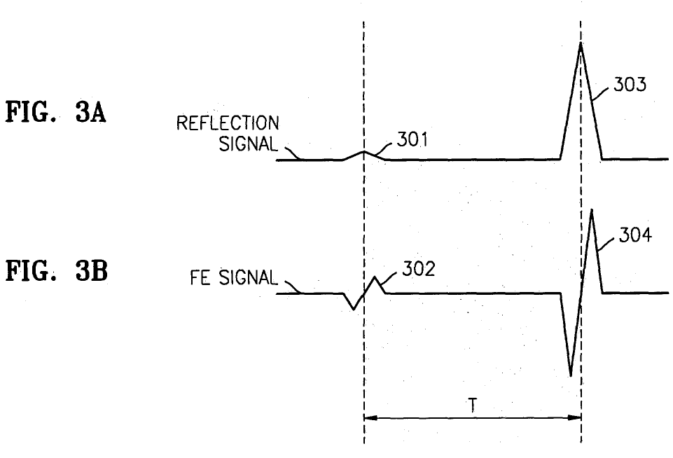

That is, after detecting a reflection signal 301 and an FE signal 302 from the surface of the disc 201, as shown in FIGS. 3A and 3B, the system controller 204 detects a time T elapsed until a reflection signal 303 and an FE signal 304 are detected from the data recording layer of the disc 201. Then, whether the disc 201 is the CD disc type or the DVD disc type is discriminated by comparing the detected time T and a reference value.

If the detected time T is greater than the reference value, it is recognized that the distance from the surface to the data recording layer of the disc 201 is long and, therefore, the system controller 204 determines that the disc 201 is the CD disc type. However, if the detected time T is less than the reference value, it is recognized that the distance from the surface to the data recording layer of the disc 201 is short and, therefore, the system controller 204 determines that the disc 201 is the DVD disc type. The reference value is determined as an adequate time value, e.g., 75 ms, in consideration of deviations in the distance from the surface to the data recording layer of the disc 201, which may be caused by the disc unbalance.

The servo controller 205 enables the driving circuit 206 to control the spindle motor 204 and the pickup 202 using a control signal provided from the system controller 204. When an instruction to stop an operation of the spindle motor 207 and to enable the focusing operation of the pickup 202 is received from the system controller 204, the servo controller 205 drives the driving circuit 206 so that the driving circuit 206 stops the operation of the spindle motor 207 and drives the focusing actuator (not shown) of the pickup 202.

The driving circuit 206 and the spindle motor 207 operate in the same way as in the conventional disc drive. The spindle motor 207 rotates the disc 201.

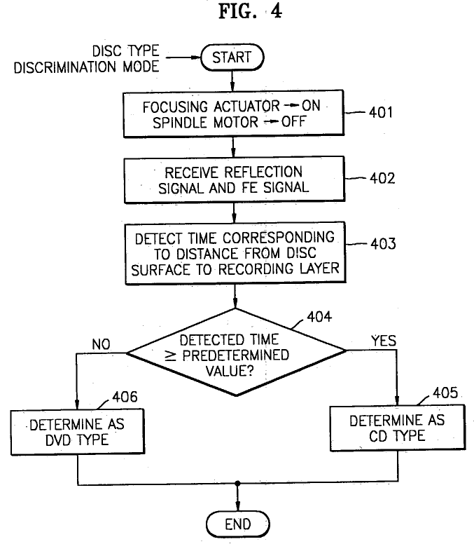

FIG. 4 is a flowchart of a method of discriminating the type of disc, according to an aspect of the present invention.

When the disc drive enters the disc type discrimination mode, at operation 401, the system controller 204 outputs the control signal to the servo controller 205 to turn on the focusing actuator of the pickup 202 while turning off the spindle motor 207. Then, the pickup 202 performs the focusing operation on the disc 201.

At operation 402, the system controller 204 receives the reflection signal 303 and the FE signal 304 output from the RF amplifier 203 according to the focusing operation. At operation 403, the system controller 204 detects the time T corresponding to the distance from the surface to the data recording layer of the disc 201 using the received reflection signal 303 and the FE signal 304. The time T can be detected by measuring the time elapsed until the light reflected from the data recording layer of the disc is detected after the light reflected from the surface of the disc is detected, as described above with reference to FIGS. 3A and 3B.

At operation 404, the system controller 204 compares the time T detected at operation 403 with a reference value. The reference value is determined in the same way as described above in connection with the system controller 204 in FIG. 2.

If the detected time T is greater than the reference value at operation 404, the system controller 204 determines that the disc 201 is the CD disc type. On the other hand, if the detected time T is less than the reference value at operation 404, the system controller 204 determines that the disc 201 is the DVD disc type.

As described above, according to the present invention, a type of disc is discriminated using a reflection signal and an FE signal detected while stopping an operation of a spindle motor and while performing a focusing operation in a disc type discrimination mode of a disc drive. Accordingly, it is possible to reduce disc type discrimination errors due to unbalance of the disc inserted into the disc drive.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of discriminating a type of disc, comprising:
stopping an operation of a motor rotating a disc;
detecting a time corresponding to a distance from a surface of the disc to a data recording layer of the disc using light reflected during a focusing operation; and
discriminating the type of disc by comparing the detected time and a reference value.

2. The method of claim 1, wherein the detection of the time corresponding to the distance comprising detecting the time using a focusing error signal detected during the focusing operation.

3. The method of claim 2, wherein the discrimination of the type of disc comprises discriminating between a CD disc type and a DVD disc type.

4. The method of claim 2, wherein the discrimination of the type of disc comprises determining the disc as a CD disc type when the detected time is greater than the reference value and as a DVD disc type when the detected time is less than the reference value.

5. The method of claim 1, wherein the discrimination of the type of disc comprises discriminating between a CD disc type and a DVD disc type.

6. The method of claim 1, wherein the discrimination of the type of disc comprises determining the disc as a CD disc type when the detected time is greater than the reference value and as a DVD disc type when the detected time is less than the reference value.

7. An apparatus for discriminating a type of disc, comprising:
a motor rotating a disc;
a pickup detecting light reflected from the disc; and
a system controller performing a control process of enabling a focusing operation on the disc while stopping an operation of the motor in a disc type discrimination mode and discriminating the type of disc according to a result of detecting a time corresponding to a distance from a surface of the disc to a data recording layer of the disc using a light reflected during the focusing operation on the disc.

8. The apparatus of claim 7, further comprising:
an amplifying unit producing a focusing error signal based on a light signal output from the pickup, wherein the system controller utilizes the focusing error signal to detect the time.

9. The apparatus of claim 8, wherein the system controller discriminates the type of disc between a CD disc type and a DVD disc type.

10. The apparatus of claim 8, wherein the system controller determines the disc as a CD disc type when the detected time is greater than a reference value and as a DVD disc type when the detected time is less than the reference value.

11. The apparatus of claim 7, wherein the system controller discriminates the type of disc between a CD disc type and a DVD disc type.

12. The apparatus of claim 7, wherein the system controller determines the disc as a CD disc type when the detected time is greater than a reference value and as a DVD disc type when the detected time is less than the reference value.

13. An apparatus to discriminate a type of a disc, comprising:
a motor;
a pickup detecting an amount of light reflected on the disc;
a driving circuit controlling the pickup to perform a focusing operation on the disc;
a radio frequency (RF) amplifier converting the amount of light detected into electrical signals and outputting a focus error (FE) signal and the electrical signals; and
a system controller discriminating the type of the disc while the focusing operation is performed and an operation of the motor is stopped, according to a result of detecting a time corresponding to a distance from a surface of the disc to a data recording layer of the disc using the electrical signals and the FE signal.

14. The apparatus of claim 13, wherein the disc is a reproducible or recordable/reproducible disc comprising a CD or a DVD.

15. The apparatus of claim 13, further comprising:
a servo controller, wherein when the disc drive is in a disc discrimination mode, the system controller stops the operation of the motor via the servo controller and controls the pickup to perform the focusing operation on the disc.

16. The apparatus of claim 15, further comprising:
a driving circuit stopping the operation of the motor, wherein the servo controller drives the pickup and the driving circuit when an instruction to stop the operation of the motor and the focusing operation of the pickup is received from the system controller.

17. The apparatus of claim 13, wherein the discrimination of the type of disc comprises determining the disc as a CD disc type when the detected time is greater than a reference value and as a DVD disc type when the detected time is less than the reference value.

18. The apparatus of claim 13, wherein the reference value is determined as a time value of 75 ms.

19. A method of discriminating a type of disc in a disc drive, which comprises a disc, a servo controller, a spindle motor, a pickup, and a system controller, the method comprising:
outputting a control signal to a servo controller to turn on the pickup while turning off the spindle motor;
performing the focusing operation on the disc;
detecting a time corresponding to a distance from a surface of the disc to a data recording layer of the disc using an amount of light reflected on the disc and an FE signal; and
comparing the time with a reference value; wherein if the detected time is greater than the reference value the disc is determined to be a CD disc type, or if the detected time is less than the reference value the disc is determined to be a DVD disc type.

20. A method of discriminating a type of a disc in a disc drive comprising a pickup and a motor, the method comprising:
detecting an amount of light reflected by the disc;
controlling the pickup to perform a focusing operation on the disc;
converting the amount of light detected into electrical signals and outputting a focus error (FE) signal; and
discriminating the type of the disc while the focusing operation is performed and an operation of the motor is stopped, according to a result of detecting a time corresponding to a distance from a surface of the disc to a data recording layer of the disc using the electrical signals and the FE signal.

21. The method of claim 20, further comprising:
determining the disc as a CD disc type when the detected time is greater than a reference value and as a DVD disc type when the detected time is less than the reference value.
